(19) United States
(12) Patent Application Publication
(10) Pub. No.: US 2014/0299223 A1
(43) Pub. Date: Oct. 9, 2014

(54) DEVICE FOR SUPPLYING CONSUMERS WITH CLEANING AND/OR DISINFECTION FLUID

(71) Applicant: KRONES AG, (US)

(72) Inventors: Olaf Schottdorf, Regensburg (DE); Christian Vogelsang, Gundelshausen (DE); Udo Donhauser, Bruck (DE)

(21) Appl. No.: 13/857,827

(22) Filed: Apr. 5, 2013

(51) Int. Cl. B67D 7/78

(52) U.S. Cl. CPC B67D 7/78
USPC 141/2; 141/18

(57) ABSTRACT

The present invention relates to a device (1) for supplying consumers (6) with a cleaning and/or disinfection fluid, preferably in a beverage filling plant, comprising a reservoir (2) for receiving a supply of cleaning and/or disinfection fluid, wherein at least two consumers (6) are connected to the reservoir (2) via a ring line (4).

### TECHNICAL FIELD

The present invention relates to a device for supplying consumers with a cleaning and/or disinfection fluid, preferably in a beverage filling plant.

### PRIOR ART

In beverage filling plants, it is known to carry out various cleaning and/or disinfection processes by means of a cleaning and/or disinfection fluid. Thus it is, for example, known to treat container closures, by means of which the containers are closed after filling with the fill product, with a disinfection fluid before attaching them to the filled container. For this purpose the container closures are usually conveyed through a bath containing disinfection fluid, in order to accomplish the disinfection. In addition, cleaning and/or disinfection fluids are also consumed in beverage filling plants by other consumers, for example in a rinser, a surge tank for gas-tight sealing of an isolator, a discharge bath, and an injector cooling line, and are also used for internal disinfection of a isolator or clean room, for maintenance disinfection, and for lubricating a capper.

In this process, the cleaning and/or disinfection fluids used by the individual consumers are supplied via separate feed lines from reservoirs which are also separate, so that for example in the cap disinfection area an independent circulation is provided within the cap disinfection module. Correspondingly, each individual consumer is provided with a separate supply line with the applicable peripherals in combination with the signal-carrying equipment required for integration.

Furthermore, due to their separate connections, the above-mentioned consumers are not incorporated in an integrated and automated cleaning concept.

### SUMMARY OF THE INVENTION

Starting from this known prior art, an object of the present invention is to provide a device for supplying consumers with cleaning and/or disinfection fluids in a beverage filling plant which enables more efficient supplying.

This object is solved by the device with the features of claim 1. Advantageous further developments arise from the dependent claims.

Accordingly, a device for supplying consumers with a cleaning and/or disinfection fluid, preferably in a beverage filling plant, is proposed, comprising a reservoir for receiving a supply of cleaning and/or disinfection fluid. In accordance with the invention, at least two consumers are connected to the reservoir via a ring line.

As a result of the fact that at least two consumers are connected to the reservoir via a ring line, it becomes possible to feed cleaning and/or disinfection fluid to different consumers from a single central reservoir. By providing a ring line, it is additionally possible to achieve a constant flow of the disinfection fluid, in such a manner that fresh disinfection fluid at a controlled temperature and with defined properties is constantly available to each consumer.

A “ring line” is here understood to mean a line which enables the disinfection fluid to flow in circulation. In this way, for example, cleaning and/or disinfection fluid is taken from the reservoir and conveyed via the ring line, and then the residual fluid not extracted in the ring line is returned to the reservoir. Accordingly, the provision of a pump enables the disinfection fluid to circulate constantly in the ring line, in order that disinfection fluid with defined properties is made available at each extraction point, and in particular for each of the consumers that are connected. Accordingly, the disinfection fluid leaving the reservoir is, for example, supplied to a first consumer, then the disinfection fluid which may have been consumed by this consumer is returned to the ring line, and subsequently conveyed to the next consumer. Thus there is no individual feed line and return flow line to each consumer connected to the ring line; instead, the ring line serves as a feed line in those parts of the ring line that are upstream of each consumer, and as a return flow line in those parts of the ring line that are downstream of each consumer.

The consumers connected to the reservoir via the ring line are for example a surge tank for gas-tight sealing of an isolator, a capper lubricator, a discharge bath, an injector cooling line, maintenance disinfection of a beverage filling plant, surface cleaning in a beverage filling plant, a rinser, external treatment of an isolator, and other consumers of cleaning and/or disinfection fluid.

It is particularly preferable for a bath for cap disinfection to be integrated in the ring line, particularly preferably as separation between a pressurized feed line and an unpressurized return flow line. In this, the bath for cap disinfection particularly preferably has an overflow for maintaining the fluid level in the bath such that there is a constant flow of disinfection fluid through the bath, from the pressurized feed line to the return flow line, which is kept substantially unpressurized by means of the overflow. Besides the separation between the pressurized feed line and the unpressurized return flow line, the integration of a bath for cap disinfection enables an additional buffer volume of disinfection fluid, since the bath itself provides an additional reservoir or capacity.

Economical handling of the cleaning and/or disinfection fluid is made possible by the centralized processing of the fluids, which in particular includes the testing of the concentration of disinfectant in the disinfection fluid, and can also comprise the filtering and temperature control of the disinfection fluid. By means of the return flow to the reservoir of the cleaning and/or disinfection fluid that is used for disinfection, there is efficient utilization of the volume of disinfection fluid in the device.

The ring line preferably comprises a heat exchanger to control the temperature of the disinfection fluid. The ring line preferably also comprises a filter device for filtering the used disinfection fluid.

The fluid level in the reservoir is preferably maintained using a diverting valve, by means of which a certain portion of disinfection fluid is fed into the ring line, and a further portion conveyed away and/or led into a cleaning unit. If all of the fluid is conveyed away, the device operates with a loss of disinfection fluid.

It is particularly preferable for the device to be integrated in an automated cleaning concept for a beverage filling plant as a whole, where the integration in the automated cleaning concept is achieved preferably by means of the supply and/or reclamation of the cleaning medium, which, for example, is reclaimed during surface cleaning and fed into the reservoir. The cleaning medium can however also be conveyed to the reservoir in a separate feed line. Correspondingly, by means of the conveying of cleaning medium into the reservoir it is possible to accomplish the cleaning both of the reservoir itself and also of the ring line and the consumers, using the cleaning medium. On completion of the cleaning procedure, the cleaning medium can then be discarded and the storage tank refilled with disinfectant.

It is particularly preferable to provide reclamation of the cleaning fluid used in a cleaning procedure, for example for cleaning surfaces. The cleaning fluid reclaimed in this manner can then be fed back to the reservoir. The level in the reservoir can also be maintained during the cleaning procedure by means of a second pump.

Analogously, when cleaning is carried out, the disinfectant still present in the reservoir, the ring line and the consumers can first be discarded, and cleaning fluid can then be introduced. The cleaning fluid can either reach the reservoir and the ring line via reclamation, or can be fed directly into the reservoir and/or the ring line via a cleaning device. Then the cleaning of the reservoir, the ring line and the consumers is carried out by conveying the cleaning fluid through them. After completion of the cleaning, the cleaning fluid can then be discarded or conveyed away, and new disinfection fluid introduced in order to restart production.

By means of the integration of the device in a cleaning concept, for example by the feeding of the required cleaning fluids into the reservoir, it is possible to accomplish without problems, within the overall cleaning concept, the cleaning of all integrated consumers, the ring line, the reservoir, and all other components. It is also possible to accomplish the processing of the cleaning medium, by using the processing devices which serve to process the disinfectant, i.e. for example a filter device or a heat exchanger. The device can accordingly also be used for processing the cleaning medium in a beverage filling plant.

The object stated above is further solved by a method with the features of claim 9. Advantageous further developments arise from the dependent claims.

Accordingly, a method for supplying consumers with a cleaning and/or disinfection fluid in a beverage filling plant is proposed, comprising the provision of a cleaning and/or disinfection fluid in a reservoir and the pumping of the cleaning and/or disinfection fluid to a consumer. In accordance with the invention, the cleaning and/or disinfection fluid is pumped via a ring line from the reservoir to at least two consumers.

In order to clean the device, a cleaning fluid is preferably introduced into the reservoir, the cleaning fluid being preferably cleaning fluid from a cleaning procedure collected by means of a collecting device, with this cleaning fluid being conveyed to the reservoir.

### BRIEF DESCRIPTION OF THE FIGURES

Further preferred embodiments and aspects of the present invention are more fully explained by the description below of the figures. The figures show:

FIG. 1 a schematic diagram of a device for supplying consumers with a cleaning and/or disinfection fluid in a first embodiment, and

FIG. 2 a device for supplying consumers with a cleaning and/or disinfection fluid in a second embodiment.

### DETAILED DESCRIPTION OF EXAMPLES OF PREFERRED EMBODIMENTS

Examples of preferred embodiments are described below with the aid of the figures. In the figures, elements which are identical or similar, or have identical effects, are designated with identical reference signs, and repeated description of these elements is in part dispensed with in the description below, in order to avoid redundancy.

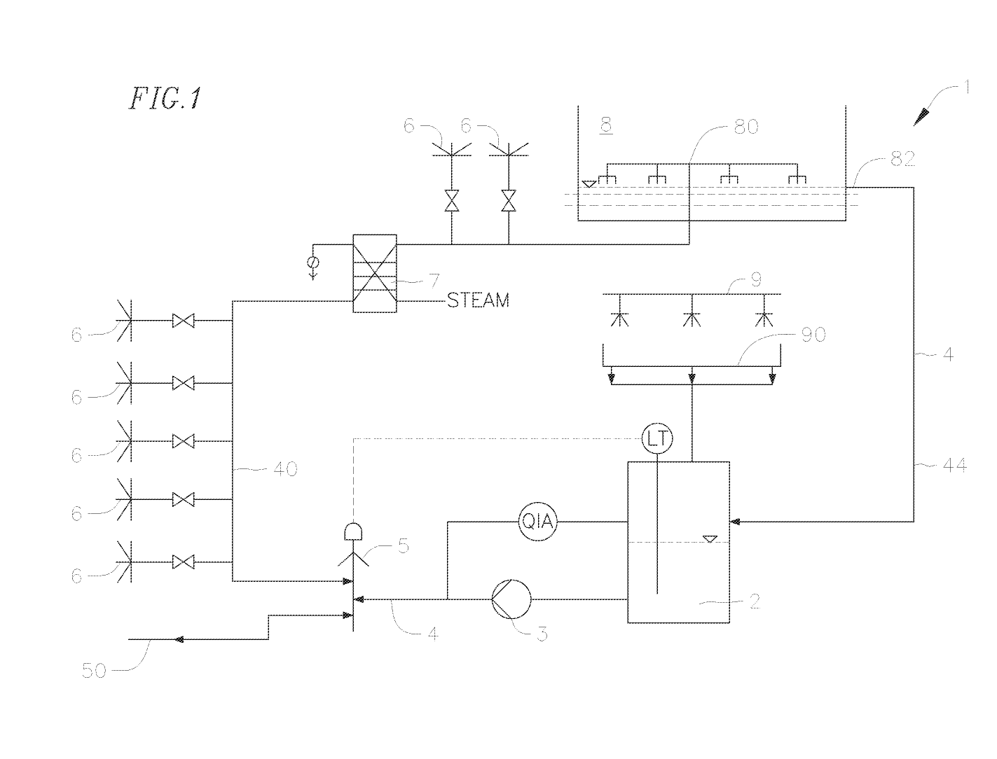

FIG. 1 shows a device 1 for supplying consumers 6 with a disinfection fluid in a beverage filling plant. A reservoir 2 is provided, for receiving a supply of disinfection fluid. A pump 3 serves to pump the disinfection fluid from the reservoir 2 into a ring line 4.

In the example embodiment shown, the ring line 4 is configured such that the disinfection fluid is conveyed from the reservoir 2 via the pump 3 and a diverting valve 5 to a section 40 of the ring line 4. A plurality of consumers 6 are either provided on this section 40 or branch off from this section 40. The consumers 6 can be for example a surge tank for gas-tight sealing of an isolator chamber, a capper lubricator, a discharge bath, an injector cooling line, a rinser, external treatment or external disinfection of a part of the beverage filling plant, an isolator cleaner, or other consumers of disinfection fluid. Each consumer 6 is shown only schematically in the figures, and any possible consumer 6 to which disinfection fluid needs to be supplied can be provided here.

The first section 40 of the ring line 4, in which the various consumers 6 can extract disinfection fluid from the ring line 4, is followed by a heat exchanger 7, by means of which the disinfection fluid can be brought to a specified temperature. In the example embodiment shown, the heat exchanger 7 is operated with thermal energy transported by means of steam, but it can also have any other manner of operation. Following the heat exchanger 7, further consumers 6 are provided in a further section 42 of the ring line 4. Next a bath 8 for cap disinfection is provided, with the disinfection fluid introduced into the bath 8 via a feed line 80 from the ring line 4. The disinfection fluid runs out of the bath 8 via a return flow line 82, in order to be conveyed back to the reservoir 2 via a further section 44 of the ring line 4.

The bath 8 for cap disinfection is integrated in the ring line 4 in such a manner that disinfection fluid can flow out of a section 42 of the ring line 4 into the bath 8, then flow through the bath, and then reach the further section 44 of the ring line 4 via the return flow line 82. Accordingly, the ring line 4, with its different sections 40, 42 and 44, forms a circuit which enables the disinfection fluid to flow in circulation, shown in FIG. 1 as a clockwise circulation, starting from the reservoir 2. In this manner it can be ensured that the disinfection fluid which is conveyed to the individual consumers 6 and the bath 8 for cap disinfection is in each case fresh, has a specified concentration, and is brought to a specified temperature by means of the heat exchanger 7. This also means that only a single processing is required in order to supply a plurality of consumers 6, with the result that the complexity of the plant can be reduced.

In reservoir 2, or at any other position on ring line 4, the fluid can be further processed, such that the disinfection fluid circulating in ring line 4 always has the specified properties, for example a specified concentration of disinfectant in the disinfection fluid, or a specified disinfection fluid temperature.

Accordingly, disinfection fluid with predetermined properties can be supplied to the consumers 6 at each extraction point. By this means the overall efficiency and the effectiveness of each disinfection process is improved. Furthermore, it is possible by this means to avoid the necessity of connecting each individual consumer 6 to its own supply of disinfection fluid. Instead, by means of the ring line a state of affairs is achieved in which the section of ring line 4 which is upstream of each consumer 6, 8 is regarded as the feed line for that consumer 6, 8, and the section of ring line 4 that is downstream of the consumer 6, 8 functions as its return flow line.

In bath 8 for cap disinfection, disinfection fluid is likewise consumed for disinfection of each molded part or container closure. This bath 8 is therefore also regarded as a consumer, although at the same time it forms part of the ring line 4, since disinfection fluid flows constantly through bath 8.

In the example embodiment shown, the heat exchanger 7 can be heated by means of steam supplied to it, in such a manner that the disinfection fluid which is conveyed in the ring line 4 is heated by the heat exchanger 7 to a specified temperature.

By means of the adjustable diverting valve 5, the level of fluid in reservoir 2 can be controlled. If the fluid level in reservoir 2 threatens to exceed a specified height, part of the fluid flow can be diverted via branch line 50 by means of the adjustable diverting valve 5. This is particularly important for the cleaning method described below.

The device shown in FIG. 1 can be integrated in a typical cleaning concept, since a cleaning fluid emitted via cleaning nozzles 9, which are provided for example for CIP (Cleaning in Place) or surface disinfection (SIP, Sterilization in Place) of another component of the beverage filling plant, is preferably collected by collecting device 90 and then conveyed to reservoir 2. Accordingly, in a stage of the method in which cleaning of the beverage filling plant is carried out, the used cleaning fluid can be collected by collecting device 90 and then conveyed to reservoir 2. It is then possible to supply this cleaning fluid to the consumers 6, 8 from reservoir 2 via the ring line 4. A certain portion of the used cleaning fluid can be returned via the adjustable diverting valve 5 through branch line 50 to the cleaning unit, so that this cleaning fluid can then be reused in the cleaning process, for example to be re-applied to an external surface of the beverage filling plant and subsequently collected again by means of the collecting device 90.

By this means it also becomes possible to integrate device 1 into a cleaning process, since the integration of the used cleaning fluids can be automated at this point.

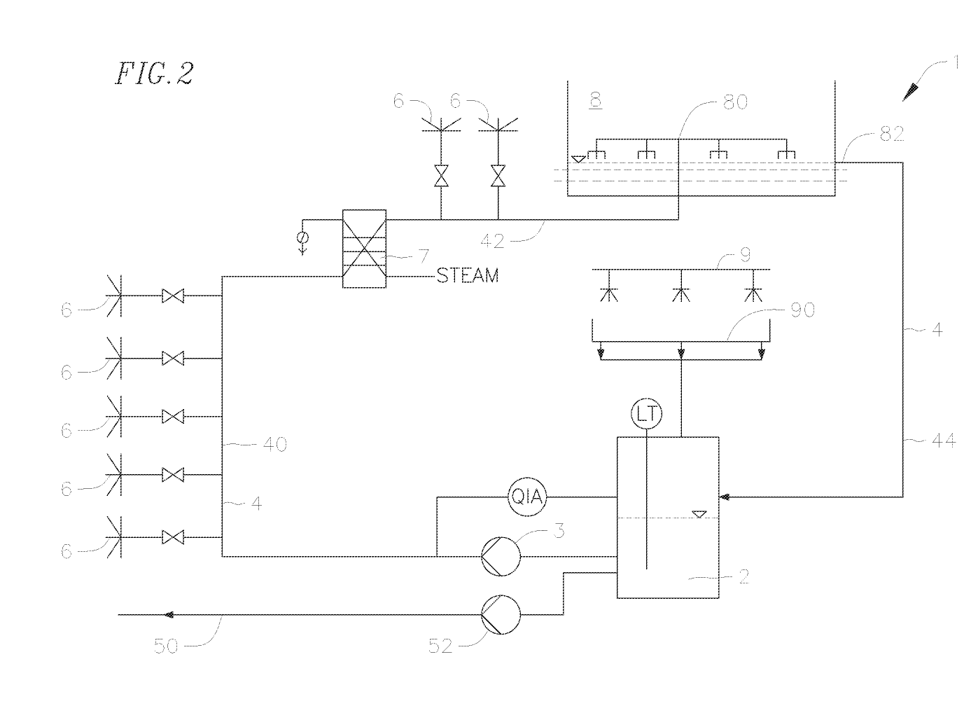

An alternative is shown in FIG. 2, which again shows a device in which, by means of a ring line 4 in different sections 40, 42, 44, a disinfection fluid is caused by a pump 3 to circulate, and is accordingly supplied to the delivery points of each of the consumers 6. Heating of the disinfection fluid can be accomplished by means of a heat exchanger 7, and a bath 8 for cap disinfection is integrated in the ring line 4.

For the purpose of emitting all or part of the fluid in the ring line 4 and the reservoir 2, the example embodiment shown in FIG. 2 is not provided with the adjustable diverting valve 5 of FIG. 1. Instead, it has a second adjustable pump 52, by means of which fluid can be pumped into branch line 50. This enables the fluid level in reservoir 2 to be lowered by operation of pump 52 if this level exceeds the specified fluid level.

It is further possible for the device to continue to operate by means of the introduction of cleaning fluid, during cleaning operations in which for example cleaning fluid is conveyed into reservoir 2 via the collecting device 90. Accordingly, by means of the pump 52, the ring line 4 can also be fully emptied and prepared for cleaning operation. On completion of the cleaning process, the ring line 4 can again be emptied by means of the pump 52, in order to permit subsequent refilling with a disinfection fluid.

By means of the heat exchanger 7, the cleaning fluid can also be brought to a specified temperature.

The return flow line 82 of the bath 8 for cap disinfection can preferably be provided as an overflow, in order that a constant flow of disinfection fluid via the feed line 80 brings about a constant flow through the bath 8, and by means of the return flow line 82 a specified fluid level is maintained in bath 8.

To the extent applicable, all individual features described in the individual example embodiments can be combined with each other and/or exchanged, without departing from the scope of the invention.

### LIST OF REFERENCE NUMERALS

1 device for supplying consumers with cleaning and/or disinfection fluid
2 reservoir
3 pump
4 ring line
40 section of the ring line
42 section of the ring line
44 section of the ring line
5 diverting valve
50 branch line
52 pump
6 consumer
7 heat exchanger
8 bath for cap disinfection
80 feed line
82 return flow line
9 cleaning nozzle
90 collecting device

1. Device for supplying consumers with a cleaning and/or disinfection fluid, preferably in a beverage filling plant, comprising a reservoir for receiving a supply of cleaning and/or disinfection fluid,
wherein
at least two consumers are connected to the reservoir via a ring line.

2. Device according to claim 1, wherein a consumer is a surge tank, a maintenance disinfection, a capper lubricator, an injector cooling line, a rinser, an external cleaning of the beverage filling plant, an isolator cleaner and/or a discharge bath.

3. Device according to claim 1, wherein a bath for disinfection of container closures is integrated in the ring line.

4. Device according to claim 3, wherein the bath is integrated in the ring line for separation between a pressurized feed line and an unpressurized return flow line.

5. Device according to claim 1, wherein the ring line comprises a heat exchanger.

6. Device according to claim 1, wherein an adjustable diverting valve and/or a pump for regulating a fluid level in the reservoir are provided.

7. Device according to claim 1, wherein a pump for conveying the cleaning and/or disinfection fluid is disposed in the ring line.

8. Device according to claim 1, wherein a collecting device for collecting a cleaning fluid of a cleaning device is provided, and the collecting device communicates with the reservoir.

9. Method for supplying consumers with a disinfection fluid in a beverage filling plant, comprising the provision of a cleaning and/or disinfection fluid in a reservoir and the pumping of the cleaning and/or disinfection fluid to a consumer,
wherein
the cleaning and/or disinfection fluid is pumped via a ring line from the reservoir to at least two consumers.

10. Method according to claim 9, wherein a cleaning fluid is introduced into the reservoir, preferably a cleaning fluid from a cleaning process collected by means of a collecting device, and said cleaning fluid is conveyed to the ring line and preferably to the consumers.
